(19) United States
(12) Patent Application Publication
(10) Pub. No.: US 2025/0030902 A1
(43) Pub. Date: Jan. 23, 2025

(54) SYSTEMS AND METHODS FOR AUTOMATICALLY ORGANIZING NARRATED MEDIA CONTENT BASED ON A MEDIA DESCRIPTION FILE

(71) Applicant: Spotify AB, Stockholm (SE)

(72) Inventors: Andreas Pålsson, Stockholm (SE); Roel Martinus Lambertus van der Ven, Falkensee (DE); Bror Ruben Lindström, Stockholm (SE); Márk Nagy, Copenhagen (DK)

(73) Assignee: Spotify AB, Stockholm (SE)

(21) Appl. No.: 18/356,966

(22) Filed: Jul. 21, 2023

(51) Int. Cl. H04N 21/235; H04N 21/239; H04N 21/472

(52) U.S. Cl. CPC H04N 21/2353; H04N 21/2393; H04N 21/472

(57) ABSTRACT

Systems and methods for automatically organizing narrated media content based on a media description file are provided. For example, a media description file may be received with narrated media content. The media description file may include information about the narrated media content, such as entitlement levels associations between narrated media content items. The narrated media content may be automatically labeled based on the media description file. A personalized user interface may be generated based on the labeled narrated media content and user subscription tiers.

### BACKGROUND

Publishers of media programs, such as podcasts, produce narrated media content. This narrated media content may be available for free to users. Many of these publishers also offer additional content for the media programs that is only available behind a paywall. For example, users with a premium subscription for a podcast may have access to advertisement-free episodes and bonus episodes. The premium content is often provided in a separate show from the free content.

This may increase work for publishers distributing narrated media content. Publishers may need to individually tag each episode as being free content or premium content and upload the episodes separately to their respective show. Confusion among users may also increase due to the multiple feeds for free and premium content. For example, a user with a premium subscription may see multiple shows that have similar content and not know which show to follow. Additionally, confusion may arise when a premium user tries to share a media program with a free user. If a premium user shares a link to the premium show with a free user, the free user may be unable to access the show because the free user does not have a premium subscription.

### SUMMARY

In general terms, this disclosure is directed to systems and methods for automatically organizing narrated media content based on a media description file. Information from a media description file may be used to automatically label narrated media content, and personalized user interfaces may be generated based on a subscription tier of a user.

One aspect is a method for automatically organizing narrated media content based on a media description file is provided. Two or more narrated audio and/or video recordings are received at a server. A media description file is received with the two or more narrated audio and/or video recordings. The two or more narrated audio and/or video recordings are automatically labeled based on the media description file. Visual data is communicated to a media playback device after the labeling.

Another aspect is a system for automatically organizing narrated media content based on a media description file is provided. The system includes one or more processors and one or more computer-readable storage devices storing data instructions. When the data instructions are executed by the one or more processors, it causes the system to receive two or more narrated media content items, receive a media description file associated with the two or more narrated media content items, automatically label the two or more narrated media content items based on the media description file, receive a request to view a media program from a user account, and cause a device to display a user interface including at least one of the two or more narrated media content items. The labels assign each of the two or more narrated media content items to a tier. When the user account is associated with a first tier, the user interface includes visual data associated with a first media content item of the two or more narrated media content items. When the user account is associated with a second tier, the user interface includes visual data associated with a second media content item of the two or more narrated media content items.

A further aspect is a non-transitory computer-readable medium is provided. Instructions are stored on the computer-readable medium that when executed by one or more processors, cause the one or more processors to receive a narrated media content item, receive a media description file associated with the narrated media content item, automatically associate the narrated media content item with a subscription tier, receive a request from a user to view a media program, automatically select a feed based on a subscription tier of the user, and cause a device to display a user interface. The media description file describes an entitlement for the narrated media content item. The narrated media content item is associated with a subscription tier based on the entitlement. The media program has a first feed associated with a first subscription tier and a second feed associated with a second subscription tier. The user interface that is displayed includes the selected feed.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic block diagram of an example media playback system for automatically organizing narrated media content based on a media description file.

FIG. 2 illustrates an example of a first method for displaying user interfaces to users based on user access to controlled narrated media content.

FIG. 3 illustrates an example of a second method for displaying user interfaces to users based on user access to controlled narrated media content.

FIG. 4 illustrates an example of a third method for displaying user interfaces to users based on user access to controlled narrated media content.

FIG. 5 illustrates a schematic block diagram of another example of a media playback system shown in FIG. 1.

FIG. 6 illustrates an example embodiment of a media description file.

FIG. 7 illustrates an example embodiment of a media description file in a markup language.

FIG. 8 illustrates an example of labelled narrated media content in a media data store.

FIG. 9 illustrates a schematic block diagram of another example of a media playback system shown in FIG. 1.

FIG. 10 illustrates a flowchart of an example method for automatically organizing narrated media content based on a media description file.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As used herein, the term “including” as used herein should be read to mean “including, without limitation,” “including but not limited to,” or the like. The term “substantially” as used herein is a broad term and is to be given its ordinary and customary meaning to a person of ordinary skill in the art (and is not to be limited to a special or customized meaning), and furthermore refers without limitation to being largely but not necessarily wholly that which is specified.

As briefly described above, embodiments of the present disclosure are directed to automatically organizing narrated media content based on a media description file. While aspects of the present disclosure may be described in the context of organizing episodes of a podcast based on a media description file, the systems and methods described herein are applicable to organizing any type of narrated media content. Narrated media content may include a combination of spoken words and musical elements in a synchronized or unsynchronized manner, or just spoken words. Further, narrated media content may include narrated audio and/or video recordings or visual representations of various content (e.g., images/photos). For example, in addition or alternative to podcasts, narrated media content may include audiobooks.

Similarly, while aspects of the present disclosure relate to organizing and displaying narrated media content based on user subscriptions, the systems and methods described herein are applicable in any situation in which access to narrated media content is controlled, whether access to the content is controlled by a paywall or other restrictions that do not require payment. For example, narrated media content may be organized and displayed based on other types of access tiers, such being a member or a follower on a media platform.

In example aspects, a narrated media content item is associated with a media description file. The media description file may describe aspects of the narrated media content item such as an entitlement level and associated episodes, as well as other metadata about the narrated media content item. Entitlement levels may be based on types of paywalls created by a publisher of the media content item to control access to the media content item. For example, the publisher may follow a freemium model, in which the publisher offers a combination of free and premium content, with basic or limited access provided for free, and exclusive or additional content requiring a paid subscription. In this example, the media description file may describe a narrated media content item as being a premium version of an episode, and it may describe the narrated media content item as being associated with a second narrated media content item which is a free version of the episode. These files may be created and/or maintained by the publisher, which shares the narrated media content item and the media description file with a media delivery system. The media delivery system may use the media description file to automatically label the narrated media content item with entitlement levels and/or associated episodes.

In further example aspects, the information on entitlement levels and associated episodes may be used to generate personalized user interfaces for users when the users view media programs. The personalized user interfaces may be based on subscription tiers of the users. For example, when a first user of a premium subscription tier views a media program, the first user may be shown a feed that includes premium episodes and bonus content. However, when a second user of a free subscription tier views the same media program, the second user may only be shown free episodes, not the premium episodes and bonus content.

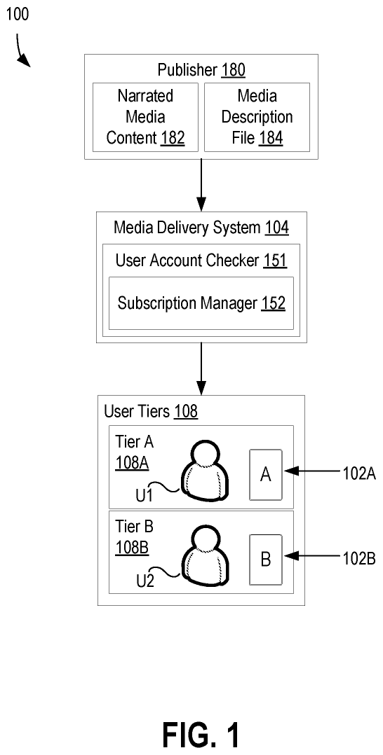

Turning to FIG. 1, an example media playback system 100 for automatically organizing narrated media content based on a media description file is shown. In the illustrated embodiment, the system 100 includes a media delivery system 104 connected to a plurality of user computing devices 102 and a publisher 180.

The media delivery system 104 may receive narrated media content 182 and a media description file 184 from the publisher 180. The narrated media content 182 may be, for example, episodes of a media program, such as a podcast. The media description file 184 may include information about the narrated media content 182, such as entitlement levels and relational information. Entitlement levels may be based on types of paywalls created by the publisher 180 to control access to the narrated media content 182 and may refer to different access tiers, such as subscription tiers 108, of which a user U1, U2 must be a part to access the narrated media content 182. Relational information may include episode associations, which may define how two or more narrated media content items in the narrated media content 182 are related. In alternative embodiments, the relational information may include relational information between the narrated media content 182 and a different media program.

In an example, the narrated media content 182 includes two episodes of a podcast. A first episode may be a free episode, and a second episode may be a premium version of the first episode available only to users of a premium payment/subscription tier. For example, the second episode may be an advertisement-free version of the first episode. In another example, the first episode may be a condensed version of the second episode, such as a preview of the second episode. In this example, the media description file 184 may describe the first episode having a free entitlement level and the second episode as having a premium entitlement level. The media description file 184 may also include an association between the first episode and the second episode, as the first episode and the second episode are different versions of the same podcast episode.

The media description file 184 may further define other information regarding the narrated media content 182. The media description file 184 may define geographical restrictions of the narrated media content 182. For example, some narrated media content items in the narrated media content 182 may be unavailable in certain countries. The media description file 184 may also define additional content associated with the narrated media content 182. This additional content may include audio data, video data, graphical data, and textual data. For example, the additional content may be a condensed text summary of a podcast episode.

The media delivery system 104 may use the media description file 184 to automatically label the narrated media content 182. The media delivery system 104 may then generate personalized user interfaces for users U1, U2 based, at least in part, on the labeled narrated media content 182 and subscription tiers 108 of the users. When a user U1, U2 requests to view a media program, the user U1, U2 may be shown different feeds based on the user's subscription tier 108. A user account checker 151 with a subscription manager 152 may check the subscription tiers 108 of accounts associated with the users U1, U2 to determine the personalized user interface each of the users U1, U2 should be shown. The personalized user interfaces may be presented on computing devices 102 of the users U1, U2.

For example, a first user U1 may be part of a free tier 108A while a second user U2 may pay for a subscription and may be part of a premium tier 108B. Based on this information, the first user U1 may be shown a first user interface that includes a free feed for a media program, and the second user U2 may be shown a second user interface that includes a premium feed for the media program.

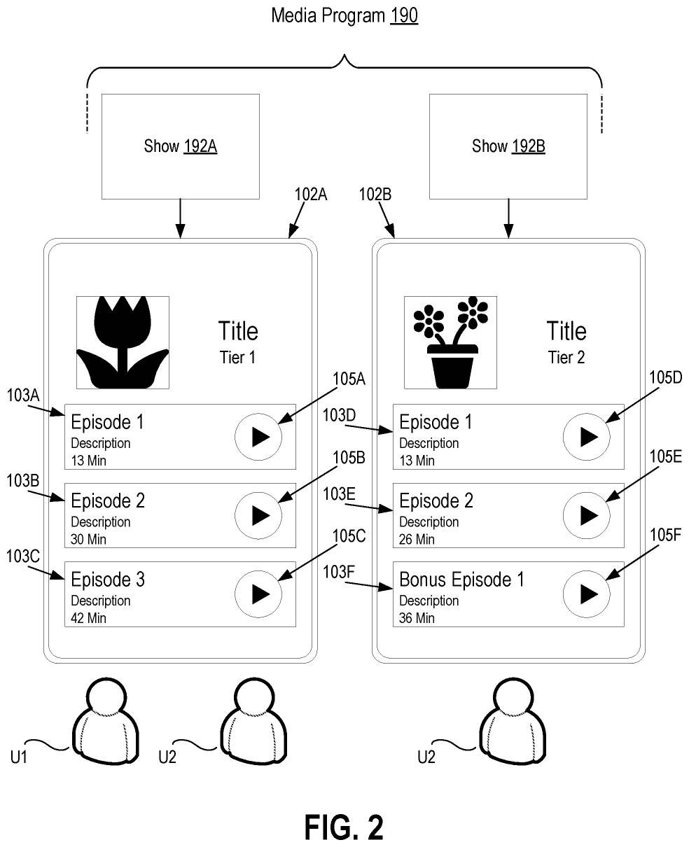

FIG. 2 illustrates a first method for displaying user interfaces to users based on user access to control narrated media content. For example, a media program 190 may control access to content through a paywall, such as by following a freemium model. The media program 190 may have content available for free to all users and premium content available only to users of a certain access tier, such as subscribers. The premium content may include premium versions of the free content, such as advertisement-free versions, as well as bonus content. Alternatively, the free content may be reduced versions of the premium content, such as previews or samples of the premium content.

In the illustrated method, to display both the free content and the premium content, the media program 190 may be multiple shows 192: a first show 192A available to all users U1, U2 and a second show 192B available to users U2 of a premium tier. The first show 192A may include a feed with the free content, and the second show 192B may include a feed with the premium content.

Each feed may include listings 103 of episodes. Each listing 103 may include information about an associated episode, such as a title, description, and length. The listings 103 may also include indicators 105 that indicate whether the episode is available for users U1, U2. In the illustrated embodiment, the indicators 105 are play buttons, which may indicate that the associated episode is available to the users U1, U2. The indicators 105 may further be actionable controls, where selection of the actionable control causes the computing device 102 to play the associated episode.

Because the first show 192A is available to all users U1, U2, a user U2 with a premium subscription may be able to view both the first show 192A and the second show 192B. This may cause confusion for the premium user U2 as the premium user U2 may see multiple shows 192 that have similar content and not know which show 192 to follow. Similarly, confusion may arise if the premium user U2 tries to share the media program 190 with the free user U1. If the premium user U2 shares a link to the second show 192B—which the premium user U2 may follow—with the free user U1, the free user U1 may be unable to access the show 192B because the free user U1 does not have a premium subscription.

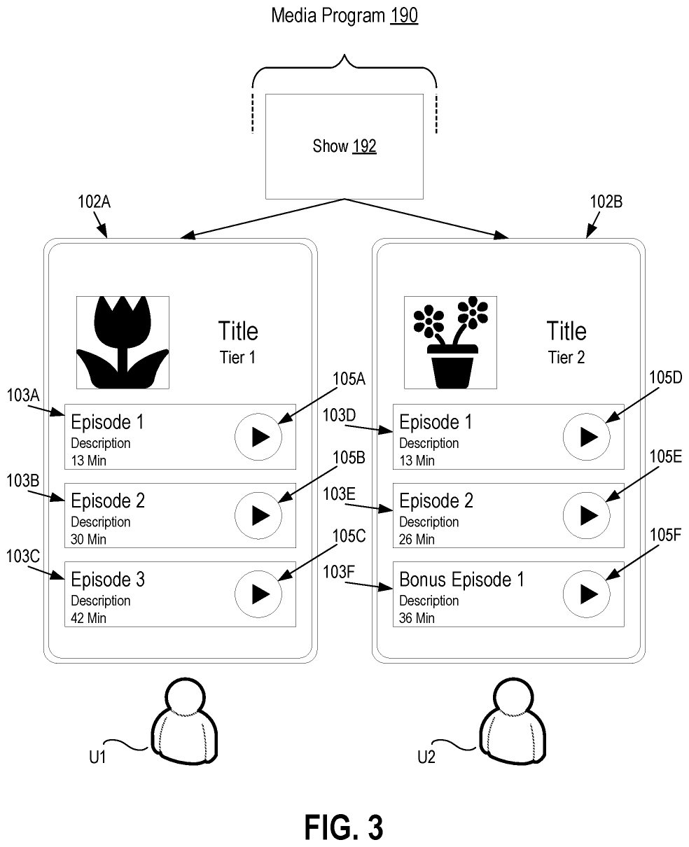

FIG. 3 illustrates a second method for displaying user interfaces to users based on user access to controlled narrated media content. Similar to what was described with relation to FIG. 2, a media program 190 may control access to content through a paywall in a freemium model, and the media program 190 may have both free content and premium content available to users U1, U2 based on the users' U1, U2 subscription tiers or other access tiers. In contrast to the method illustrated in FIG. 2, in the method illustrated in FIG. 3, the media program 190 may be a single show 192 that is associated with both a feed for the premium content and a feed for the free content. As described herein, when a user U1, U2 requests to view the show 192, the subscription tier of the user U1, U2 is checked, and a personalized user interface with the feed for the users' U1, U2 subscription tier is presented to the user U1, U2. The user U2 with a premium subscription may see the premium content in a personalized user interface, while a user U1 without a premium subscription may see only the free content in a personalized user interface. As with the user interfaces described with relation to FIG. 3, the personalized user interfaces may include listings 103 of episodes that may include indicators 105, such as actionable controls.

By having a single show 192 associated with both the feed for the premium content and the feed for the free content, confusion may be reduced for the users U1, U2. Because the media program 190 includes only one show 192, a user U2 with a premium subscription does not see multiple versions of the show 192. Similarly, if the premium user U2 sends a link to the show 192 to a free user U1, the free user U1 can still access the show 192 but will be shown a personalized user interface with the appropriate feed for the free user U1.

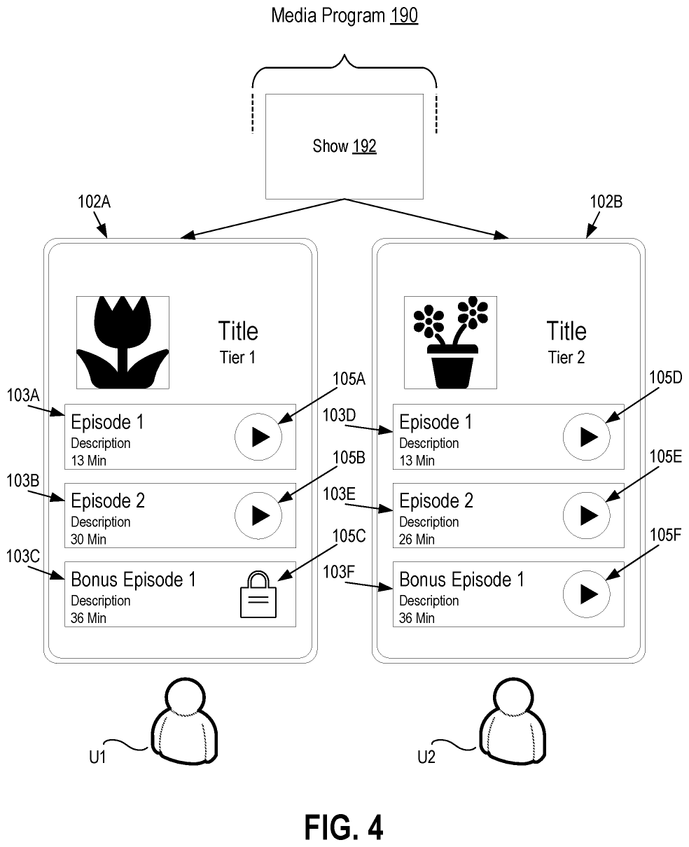

FIG. 4 illustrates a third method for displaying user interfaces to users based on user access to controlled narrated media content. Like in FIG. 3, a media program 190 may have both free content and premium content available to users U1, U2 based on the users' U1, U2 subscription tiers, and personalized user interfaces may be presented to the users U1, U2 when the users U1, U2 request to view a show 192. As described above, the user interfaces may include listings 103 of episodes and indicators 105.

When premium content is associated with free content—because the premium content are alternative versions of the free content, for example—the listings 103D-E for the premium content may be displayed to users U2 of a premium tier while the listings 103A-B for the associated free content may be displayed to users U1 of a free tier. However, rather than only presenting listings 103F for the premium content without associated free content in a feed for users U2 of a premium tier, a feed for users U1 of a free tier may include listings 103C for the premium content but include an indicator 105 that the premium content is unavailable to users U1 without a premium subscription. In the illustrated example, “Bonus Episode 1” may be a premium episode, so when a listing 103F for “Bonus Episode 1” is presented to a user U2 with a premium subscription, the listing may include indicator 105 that is an activatable control that when activated may cause the computing device 102B to play the episode. However, when a listing 103C for “Bonus Episode 1” is presented to a user U1 without a premium subscription, the listing 103C may include an indicator 105, such as a lock icon, that indicates that the episode is not available to the user U1 without a premium subscription.

In alternative embodiments, a personalized user interface may include a listing 103 that has an indicator 105 that indicates that an episode is unavailable for a user U1 for reasons other than the user U1 not having a premium subscription. For example, the indicator 105 may indicate that the episode is not available to the user U1 based on a geographical restriction.

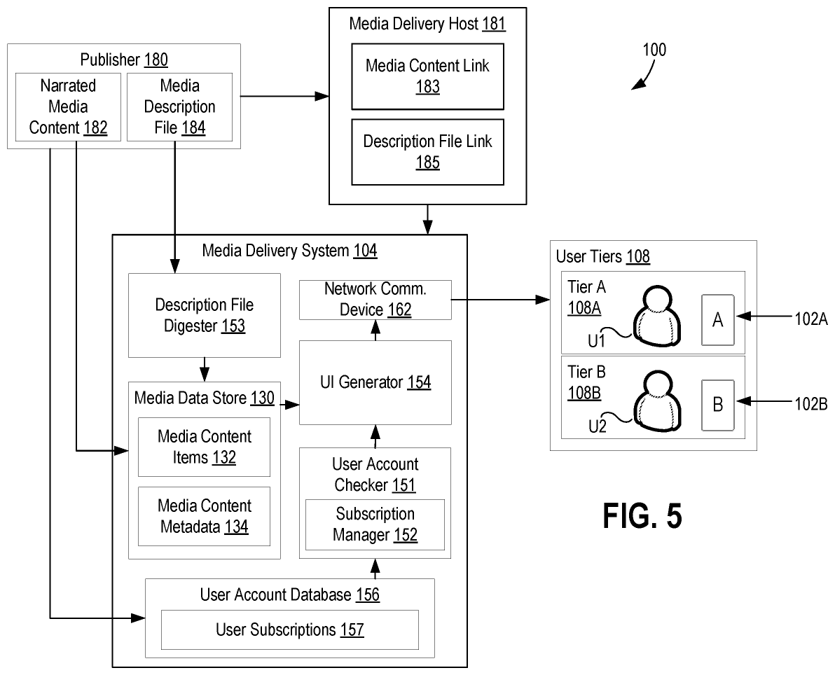

Turning to FIG. 5, another example of the media playback system 100 of FIG. 1 is shown. In the illustrated example, the system 100 includes a media delivery system 104, a publisher 180, a plurality of computing devices 102 belonging to users U1, U2 in various user subscription tiers 108, and a media delivery host 181.

Like as described in relation to FIG. 1, the media delivery system 104 receives narrated media content 182 and a media description file 184 from the publisher 180. The narrated media content 182 may be for a media program. For example, the narrated media content 182 may be episodes of a podcast. The media description file 184 may include information about the narrated media content 182. For example, the media description file 184 may include information regarding entitlement levels and associated episodes for the narrated media content 182. The publisher 180 may control access to the narrated media content 182 using a paywall. Users U1, U2 may have different access to the narrated media content 182 based on the users' U1, U2 access tiers, such as subscription tiers.

In the illustrated embodiment, the publisher 180 supplies the media delivery host 181 with a media content link 183, which references the narrated media content 182, and a description file link 185, which references the media description file 184. In embodiments in which the narrated media content 182 includes multiple narrated media content items, multiple media content links 183 may be used, each referencing one of the multiple narrated media content items. The media delivery host 181 may share the media content link 183 and the description file link 185 with the media delivery system 104 to provide the media delivery system 104 access to the narrated media content 182 and the media description file 184. In alternative embodiments, the publisher 180 may share the media content link 183 and/or the description file link 185 directly with the media delivery system 104, rather than the media delivery host 181. In further embodiments, rather than the media content link 183 and the description file link 185, the publisher 180 may share the narrated media content 182 and the media description file 184 directly with the media delivery host 181 and/or the media delivery system 104.

The media delivery system 104 may use the media content link 183 to access the narrated media content 182. The narrated media content 182 may be saved by the media delivery system 104 in a media data store 130 with other media content items 132.

The media delivery system 104 may use the media description file link 185 to access the media description file 184. After accessing the media description file 184, a description file digester 153 may extract information from the media description file 184. The description file digester 153 may read the media description file 184 for information such as entitlement levels for episodes and episode associations, as well as other data. The description file digester 153 may use the information from the media description file 184 to label the narrated media content 182. These labels may assign narrated media content items of the narrated media content 182 to access tiers, such as subscription tiers, and may describe associations and other relationships between narrated media content items. The description file digester 153 may store the labels and other extracted information in a media data store 130 with the media content items 132 and other media content metadata 134. This labeling may assign the narrated media content 182 to feeds for the media program, such as a free feed and a premium feed, in accordance with the subscription tiers.

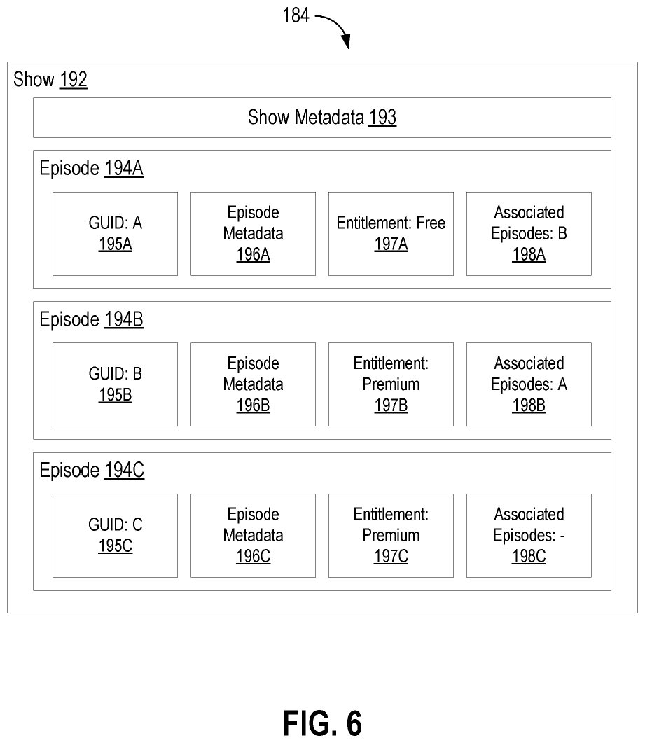

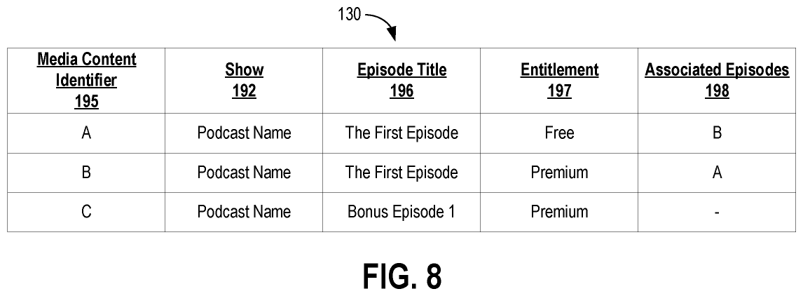

FIGS. 6 & 7 illustrate examples of a media description file 184, while FIG. 8 illustrates an example of labeled narrated media content items as stored in the media data store 130. FIG. 6 shows a block diagram illustrating an embodiment of a media description file 184. The media description file 184 may contain information for a show 192, such as a podcast show. This information may include metadata 193 for the show 192. For example, the show metadata 193 may include a title, description, an image, and a link for the show 192. In alternative embodiments, additional or alternative information about the show 192 is included in the show metadata 193.

The media description file 184 may further include information about episodes 194 of the show 192, such as identifiers 195, episode metadata 196, entitlement levels 197, and episode associations 198. The identifier 195 may be a unique identifier, such as a globally unique identifier (GUID). The episode metadata 196 may include information about the episode 194, such as a title, description, and link to the episodes 194. In alternative embodiments, additional or alternative information about the episodes 194 is included in the media description file 184.

The entitlements 197 may refer to access tiers, such as a subscription tier, necessary to access the episode based on a paywall created by a publisher of the show 192. For example, a first episode 194A may be an episode available for free to all users, while a second episode 194B and a third episode 194C may require a premium subscription to listen to the episodes 194B-C. In this example, the first episode 194A may have an entitlement level 197A of “free,” while the second episode 194B and the third episode 194C may have entitlement levels 197B-C of “premium.” In alternative embodiments, rather than listing an entitlement 197 for each episode 194, entitlements 197 may only be listed for premium episodes, such as the second episode 194B and the third episode. In such embodiments, it may be assumed that episodes 194 that do not have an entitlement 197 have an entitlement 197 of “free.” Alternatively, entitlements 197 may only be listed for the free episodes 194A, and episodes 194 without an entitlement 197 are assumed to be premium.

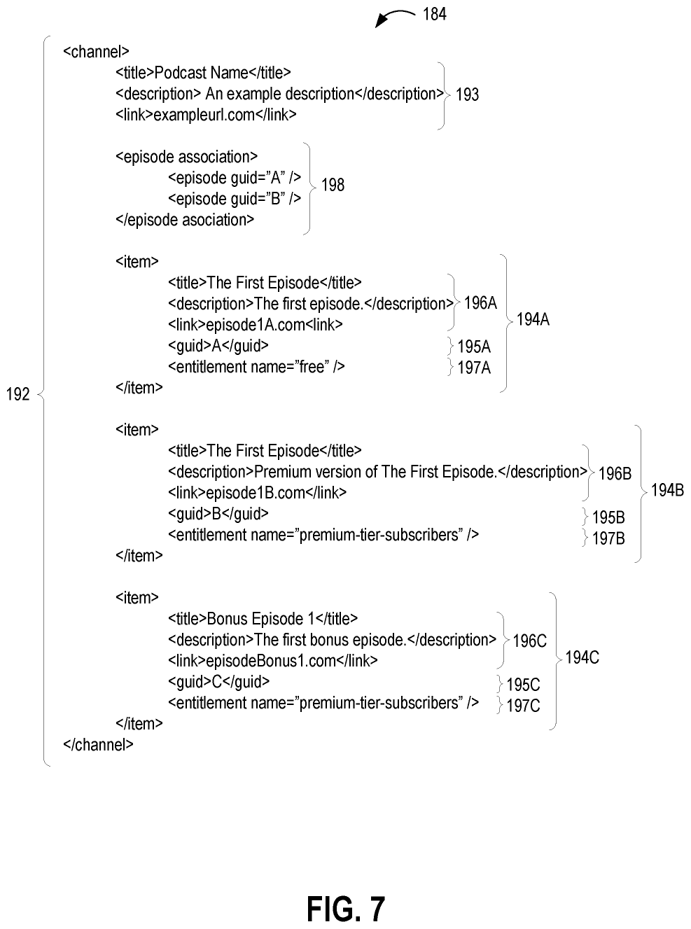

The episode associations 198 may describe relationships between two or more of the episodes 194. For example, the second episode 194B may be a premium, advertisement-free version of the first episode 194A. In this example, the media description file 184 may list the second episode 194B as an associated episode 198A for the first episode 194A and may similarly list the first episode 194A as an associated episode 198B for the second episode 194B. The associations 198A-B may use the identifiers 195A-B of the associated episodes 194A-B. Some episodes, such as the third episode 194C may be bonus content that is only available at certain entitlement levels. Accordingly, the third episode 194C may have no episodes 194 listed as an associated episode 198C in the media description file 184. In the illustrated embodiment, the episode associations 198 are included with the information for each episode 194. In alternative embodiments, such as the embodiment shown in FIG. 7, the episode associations 198 may be included with information about the show 192.

FIG. 7 illustrates an example of a media description file 184 in a markup language. In an embodiment, the media description file 184 may be created in Really Simple Syndication (RSS). In alternative embodiments, the media description file 184 may be created in another markup language, or the media description file 184 may be created in other text-encoding systems.

Like is shown in FIG. 6, the media description file 184 in the illustrated embodiment includes information for a show 192, including metadata 193 for the show 192. The media description file 184 further includes information about episodes 194 of the show 192. The information for episodes 194 may include episode metadata 196, an identifier 195, such as a GUID, and entitlements 197. In the illustrated embodiment, each episode 194 has an entitlement 197 listed, regardless of whether the episode 194 is a premium episode or a free episode. As described above, in alternative embodiments, entitlements 197 may only be listed for premium episodes, such as the second episode 194B and the third episode, and it may be assumed that episodes 194 that do not have an entitlement 197 have an entitlement 197 of “free.”

In contrast to FIG. 6, the media description file 184 shown in FIG. 7 includes episode associations 198 outside of the information about the episodes 194. In the illustrated embodiment, a single episode association 198 is shown between a first episode 194A and a second episode 194B, as indicated by the GUIDs 195A-B. In other embodiments, multiple episode associations 198 may be included in the media description file 184.

In further embodiments beyond those shown in FIGS. 6 & 7, additional or alternative information about the show 192 or episodes 194 may be included in the media description file 184. Additionally, in alternative embodiments, the order in which elements of the media description file 184 are listed may be different.

FIG. 8 illustrates an example embodiment of labeled narrated media content in a media data store 130. In the illustrated embodiment, the labeled narrated media content is stored in a table format in the media data store 130. In alternative embodiments, the labeled narrated media content may be stored in a different format. The rows in the table represent different narrated media content items, such as episodes of a show, and the columns in the table represent different labels and other information for the narrated media content items.

In the illustrated embodiment, the episodes are stored with labels for entitlements and associated episodes. In further embodiments, additional columns for other labels may be included in the table, such as a column for geographical restriction labels. In alternative embodiments, rather than store episode associations as labels for each episode individually, episode associations may be stored with other information for a show, like how episode associations 198 are listed with other show metadata 193 in the media description file 184 of FIG. 7.

The episodes are also stored with other metadata about the episode, such as an identifier for the episode, a show title, and an episode title. In an embodiment, the identifier is a GUID used in a media description file. In alternative embodiments, additional or alternative identifiers may be used, such a uniform resource identifier or a universal resource locator. In further embodiments, additional or alternative metadata may be listed in the media data store 130 for each episode, such as a description, a link to the episode, and a length of the episode.

Returning to FIG. 5, the media delivery system may also receive information about user subscriptions 157—or other user access to the narrated media content 182—from the publisher 180. Users U1, U2 may subscribe to a media program directly with a publisher 180, and the publisher 180 may share that information with the media delivery system 104. For example, the users U1, U2 may link an account associated with the media delivery system 104 to a subscription with the publisher 180, and the publisher 180 may inform the media delivery system 104 that the account has a subscription. In alternative embodiments, the publisher 180 may share information about user subscriptions 157 with the media delivery host 181, and the media delivery host 181 may share the user subscriptions 157 with the media delivery system 104. In further embodiments, the media delivery system 104 or the media delivery host 181 may receive the information about user subscriptions 157 directly from the users U1, U2. The media delivery system 104 may store the user subscriptions 157 in a user account database 156.

Using the media content metadata 134 stored in the media data store 130 and the user subscriptions 157 in the user account database 156, the media delivery system 104 may provide personalized user interfaces to the computing devices 102 of the users U1, U2. Users U1, U2 may see different user interfaces based, at least in part, on subscription tiers 108 of which the users U1, U2 are a part. In the illustrated embodiment, there are two user tiers 108: a first user tier 108A which may represent a free tier and a second user tier 108B which may represent a premium tier.

The media delivery system 104 may have a user interface generator 154 that generates the personalized user interfaces. In alternative embodiments, the user interfaces are generated by the computing devices 102 using data from the media delivery system 104, such as from the user interface generator 154.

When a user U1, U2 requests to view a media program, the media delivery system 104 may receive a request from an account of the user U1, U2, and the user interface generator 154 may generate a personalized user interface for the user U1, U2. The user interface generator 154 may use information from a user account checker 151 in generating the user interface. The user account checker 151 may have a subscription manager 152 that uses the data on user subscriptions 157 in the user account database 156 to determine the subscription tier 108 of the user U1, U2. For example, if a user U2 that is part of the premium tier 108B requests to view a media program, the subscription manager 152 may check the user account database 156 and determine that the user U2 has an account associated with a premium subscription in the user subscriptions 157.

The user account checker 151 may also check the user account database 156 for other information about the user U2 that may be used by the user interface generator 154, such as a type of computing device 102B associated with the user U2. In alternative embodiments, the user account checker 151 may additionally or alternatively use information received with the request to view the media program, such as a type of computing device 102B associated with the user U2 from which the request was received. This information may be used, for example, to determine a layout of the user interface or to select a media file format that is compatible with the computing device 102B to use for the media content items 132 linked in or associated with the user interface.

The user interface generator 154 may also use information from the media data store 130 in the personalized user interfaces. This may include metadata 134, such as titles and descriptions of episodes, as well as links to media content items 132 or identifiers that can be used to identify media content items 132. The media content items 132 that are linked or otherwise associated with the user interface may be selected based on the subscription tier 108 of the user U1, U2 determined by the subscription manager 152. The media content items 132 that are selected for the user interface may be selected individually based on the subscription tier 108 of the user U1, U2, or a feed that has associated media content items 132 may be selected based on the subscription tier 108 of the user U1, U2. For example, a user interface that is generated to be presented to the user U1 in the free tier 108A may include free content from the media content items 132. Alternatively, a user interface that is generated for the user U2 in the premium tier 108B may include premium content from the media content items 132, such as advertisement-free episodes and/or bonus content. In an embodiment, personalized user interfaces may have an appearance to the user interfaces depicted in FIGS. 3-4.

After the user interface generator 154 generates the personalized user interface, the user interface may be transmitted to a computing device 102 of the user U1, U2 through a network communication device 162. The network communication device 162 may communicate with the computing device 102 over a wide area network, for example. In an embodiment, the network communication device 162 includes a content delivery network, which may communicate the user interface and other associated content, such as media content items 132 associated with the user interface, in an encrypted manner.

After receiving the personalized user interface, the computing device 102 may present the user interface to the user U1, U2. The user U1, U2 may then interact with the user interface to play media content items 132 that are part of the subscription tier 108 of the user U1, U2 of the computing device 102.

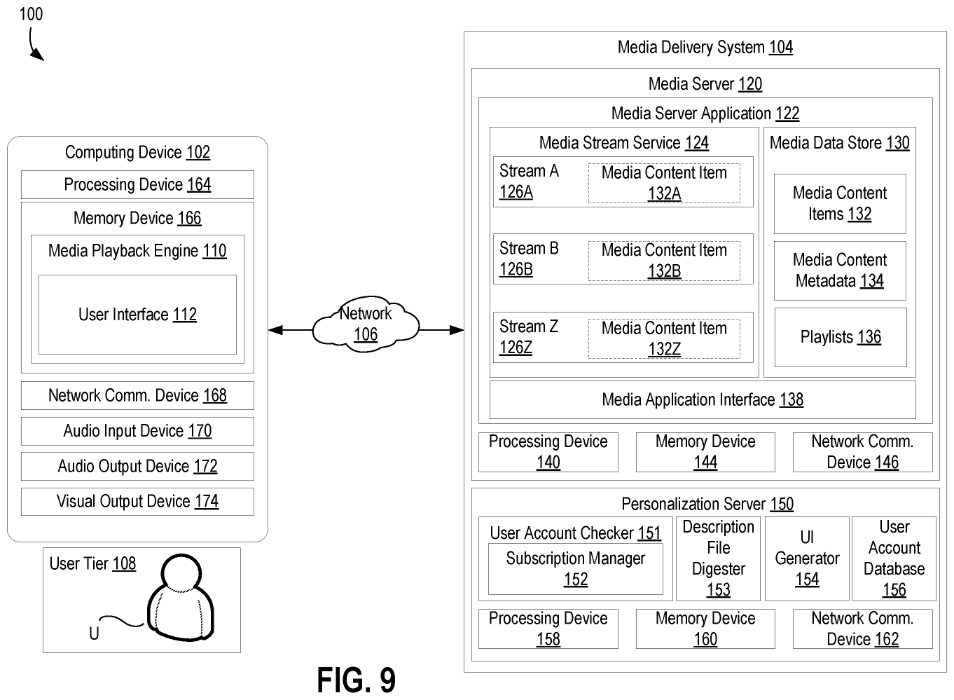

FIG. 9 illustrates a schematic block diagram illustrating another example of the media playback system 100 shown in FIG. 1. In the illustrated embodiment, the publisher 180 of FIG. 1 is not shown. In this example, the media playback system 100 includes the computing device 102 for a user U of a user tier 108 and the media delivery system 104. The network 106 is also shown for communication between the computing device 102 and the media delivery system 104.

As described herein, the computing device 102 operates to play media content items to a user U through the media playback engine 110. The computing device 102 may be, for example, a media playback device. In some embodiments, the computing device 102 operates to play media content items 132 that are provided (e.g., streamed, transmitted, etc.) by a system remote from the computing device 102 such as the media delivery system 104, another system, or a peer device. Alternatively, in some embodiments, the computing device 102 operates to play media content items stored locally on the computing device 102. Further, in at least some embodiments, the computing device 102 operates to play media content items that are stored locally as well as media content items provided by remote systems.

In some embodiments, the computing device 102 includes a processing device 164, a memory device 166, a network communication device 168, an audio input device 170, an audio output device 172, and a visual output device 174. In the illustrated example, the memory device 166 includes the media playback engine 110 which may display different user interfaces 112 to the user U based on the tier 108 of which the user U is a part. Other embodiments of the computing device 102 include additional, fewer, or different components. Examples of computing devices include a smartphone, a smart speaker, and a computer (e.g., desktop, laptop, tablet, etc.).

In some embodiments, the processing device 164 comprises one or more processing devices, such as central processing units (CPU). In other embodiments, the processing device 164 additionally or alternatively includes one or more digital signal processors, field-programmable gate arrays, or other electronic circuits. In some embodiments, the processing device 164 includes at least one processing device that can execute program instructions to cause the at least one processing device to perform one or more functions, methods, or steps as described herein.

The memory device 166 operates to store data and program instructions. In some embodiments, the memory device 166 stores program instructions for the media playback engine 110 that enables playback of media content items received from the media delivery system 104. As described herein, the media playback engine 110 is configured to communicate with the media delivery system 104 to receive one or more media content items—e.g., through the media content streams 126 (including media content streams 126A, 126B, and 126Z).

The memory device 166 includes at least one memory device. The memory device 166 typically includes at least some form of computer-readable media. Computer readable media include any available media that can be accessed by the computing device 102. By way of example, computer-readable media can include computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory and other memory technology, compact disc read only memory, blue ray discs, digital versatile discs or other optical storage, magnetic cassettes, magnetic tape, magnetic disk storage or other magnetic storage devices, or any other medium that can be accessed by the computing device 102. In some embodiments, computer readable storage media is non-transitory computer readable storage media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The network communication device 168 is a device that operates to communicate data across the network 106. The network communication device 168 allows the computing device 102 to communicate with remote devices, such as with the media server 120 and the personalization server 150 of the media delivery system 104. Examples of the network communication device 168 include wired and wireless data communication devices, such as a cellular, WIFI, BLUETOOTH™, LoRa, and wired (e.g., Ethernet) communication device.

Some embodiments include an audio input device 170 that operates to receive audio input, such as voice input provided by the user. The audio input device 170 typically includes at least one microphone. In some embodiments, the audio input device 170 detects audio signals directly, and in other embodiments, the audio input device 170 communicates with another device that detects the audio signals (such as through a Bluetooth-connected microphone).

The audio output device 172 operates to output audible sounds, such as the media content and other audio outputs, such as audio cues. In some embodiments, the audio output device 172 generates media output to play media content to the user U. Examples of the audio output device 172 include a speaker, an audio output jack, and a Bluetooth transceiver (such as for communication with a Bluetooth-connected speaker). In some embodiments, the audio output device 172 generates an audio output directly, and in other embodiments, the audio output device 172 communicates with another device that generates the audio output. For example, the audio output device 172 may transmit a signal through an audio output jack or a Bluetooth transmitter that can be used to generate the audio signal by a connected or paired device such as headphones or a speaker.

Some embodiments also include a visual output device 174. The visual output device 174 includes one or more light-emitting devices that generate a visual output. Examples of the visual output device 174 includes a display device (which can include a touch-sensitive display device) and lights such as one-or-more light-emitting diodes (LEDs). The visual output device 174 may operate to display the user interface 112 to the user U.

Still with reference to FIG. 9, the media delivery system 104 includes one or more computing devices, such as the media server 120 that provides media content items 132 to the computing device 102, and the personalization server 150 that labels media content items 132 and generates personalized user interfaces 112. Each of the media server 120 and the personalization server 150 can include multiple computing devices in some embodiments. Although shown as separate servers, the media server 120 and the personalization server 150 may be the same server.

In some embodiments, the media delivery system 104 operates to transmit media content items 132 to one or more media playback devices such as the computing device 102.

In this example, the media server 120 comprises a media server application 122, a processing device 140, a memory device 144, and a network communication device 146. The processing device 140, memory device 144, and network communication device 146 may be similar to the processing device 164, memory device 166, and network communication device 168 respectively, which have been previously described.

In some embodiments, the media server application 122 operates to stream music or other audio, video, or other forms of media content. The media server application 122 includes a media stream service 124, a media data store 130, and a media application interface 138.

The media stream service 124 operates to buffer media content such as media content items 132 (including 132A, 132B, and 132Z) for streaming to one or more streams 126 (including 126A, 126B, and 126Z).

The media application interface 138 can receive requests or other communication from the media playback devices (such as the computing device 102) or other systems, to retrieve media content items from the media delivery system 104. For example, in FIG. 9, the media application interface 138 receives communications from the media playback engine 110 of the computing device 102.

In some embodiments, the media data store 130 stores media content items 132, media content metadata 134, and playlists 136. The media data store 130 may comprise one or more databases and file systems. Other embodiments are possible as well. As noted above, the media content items 132 may be audio, video, or any other type of media content, which may be stored in any format for storing media content. For example, media content items 132 may be songs, audiobooks, podcasts, advertisements, or any other form of narrated media content.

The media content metadata 134 operates to provide information associated with the media content items 132. In some embodiments, the media content metadata 134 includes one or more of title, artist, lyrics, album name, length, genre, mood, era, captions, or other media metadata. The media content metadata 134 may also include labels assigned to media content items 132 based on a media description file, as described above.

The playlists 136 operate to identify one or more of the media content items 132. In some embodiments, the playlists 136 identify a group of the media content items 132 in a particular order. In other embodiments, the playlists 136 merely identify a group of the media content items 132 without specifying a particular order. Some, but not necessarily all, of the media content items 132 included in a particular one of the playlist 136 are associated with a common characteristic such as a common genre, mood, or era.

In this example, the personalization server 150 includes a user account checker 151 with a subscription manager 152, a description file digester 153, a user interface generator 154, a user account database 156, a processing device 158, a memory device 160, and a network communication device 162.

In some embodiments, any one or more of the functions, methods, and operations described herein as being performed by the personalization server 150—or components of the personalization server 150, such as the user interface generator 154—can alternatively be performed by the media playback engine 110. This may include embodiments where the media delivery system 104 does not include a personalization server 150 and embodiments where the personalization server 150 cooperates with the media playback engine 110 and the functions are split between those components.

Components of the personalization server 150 can operate on a single computing device, or by cooperation of multiple computing devices. For example, the user interface generator 154 can operate solely on the computing device 102 or solely on the personalization server 150. Alternatively, portions of components of the personalization server 150 can be performed by one or more other computing devices, such as by data communication between the computing device 102 and the media delivery system 104.

The processing device 158, memory device 160, and network communication device 162 may be similar to the processing device 164, memory device 166, and network communication device 168 respectively, which have each been previously described.

In various embodiments, the network 106 includes one or more data communication links, which may include multiple different types. For example, the network 106, can include wired and/or wireless links, including BLUETOOTH™, ultra-wideband (UWB), 802.11, ZigBee, cellular, LoRa, and other types of wireless links. Furthermore, in various embodiments, the network 106 is implemented at various scales. For example, the network 106 can be implemented as one or more local area networks (LANs), metropolitan area networks, subnets, wide area networks (such as the Internet), or can be implemented at another scale. Further, in some embodiments, the network 106 includes multiple networks, which may be of the same type or of multiple different types.

Although FIG. 9 illustrates only a single computing device 102 in communication with a single media delivery system 104, in accordance with some embodiments, the media delivery system 104 can support the simultaneous use of multiple computing devices 102. Additionally, the computing device 102 can simultaneously access media content from multiple media delivery systems 104.

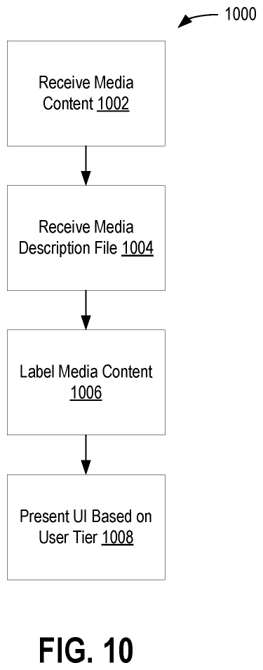

Referring now to FIG. 10, a flowchart of an example method 1000 for automatically organizing narrated media content based on a media description file is shown. The method 1000 includes operations 1002, 1004, 1006, 1008.

The operation 1002 may be performed to receive narrated media content. In an embodiment, the narrated media content is one or more episodes of a podcast or other media program. Access to the narrated media content may be controlled by a publisher, which may be done through a paywall. Accordingly, the narrated media content may be for multiple feeds of the media program, such as a free feed and a premium feed, with some episodes assigned to the free feed and some episodes assigned to the premium feed. In an embodiment, the episodes for the premium feed may include alternative versions of the episodes for the free feed, such as advertisement-free versions of the free episodes or other condensed versions. The episodes for the premium feed may also include bonus or additional content that does not have associated content in the free feed.

In an embodiment, the operation 1002 may be performed by a media delivery system. The media delivery system may receive the narrated media content and store it in a media data store. As described above, the narrated media content may be received directly from a publisher, or the publisher may go through a media delivery host to distribute the narrated media content to the media delivery system, potentially through the distribution of a media content link.

The operation 1004 may be performed to receive a media description file. The media description file may describe entitlement levels that refer to different access tiers, such as subscription tiers, for the narrated media content received during the operation 1002, as well as relational information such as associations between narrated media content items in the received narrated media content. The entitlement levels may be based on a paywall created by a publisher of the narrated media content for controlling access to the media content. For example, the media description file may define which episodes are for the free feed and which episodes are for the premium feed. The media description file may further define the relational information between associated episodes in the free and premium feeds. For example, the media description file may define that a first episode is a premium version of a second episode that is in the free feed. The media description file may also define geography restrictions and other metadata of the narrated media content.

In an embodiment, the operation 1004 is performed by a media delivery system. Like with the narrated media content described in the operation 1002, the media delivery system may receive the media description file directly from a publisher or from a media delivery host, potentially through the distribution of a description file link.

The operation 1006 may be performed to label the narrated media content received during the operation 1002. The narrated media content may be narrated based on the media description file received during the operation 1004. For example, the narrated media content may be labeled with the entitlement levels defined in the media description file, such as free and premium. The media narrated media content may also be labeled with episode associations as defined in the media description file. Other metadata from the media description file, including geography restrictions, may be included in the information with which the narrated media content is labeled.

In an embodiment, the operation 1006 may be performed by a description file digester. The description file digester may read a media description file and extract information about narrated media content from the file. The narrated media content and associated information and metadata extracted from the media description file may then be stored in a media data store.

The operation 1008 may be performed to present a personalized user interface based on a user's subscription tier. The personalized user interface may also be based on the labels assigned to the narrated media content during the operation 1006. For example, when a user of a free tier requests to view a media program, a personalized user interface may be presented to the user that includes a free feed comprising episodes of the media program that have been labeled as part of a free tier during the operation 1006. Similarly, when a user of a premium tier requests to view a media program, a personalized user interface may be presented to the user that includes a premium feed comprising episodes of the media program that have been labeled as part of a premium tier during the operation 1006. As described above, FIG. 3 illustrates examples of personalized user interfaces.

In an alternative embodiment, the free feed may contain some of the narrated media content that has been labeled as part of the premium tier during the operation 1006. However, in this alternative embodiment, episodes that have been labeled as part of the premium tier may be presented in free feed with a listing that includes an indication that the episode is not available for users associated with the free tier. In contrast, episodes that have been labeled as part of the free tier may be presented in the free feed with listings that includes activatable controls that when activated causes a device to play the episodes in the free tier. As described above, FIG. 4 illustrates examples of personalized user interfaces in this alternative embodiment.

In an embodiment, the operation 1008 may be performed by a user interface generator and a user's computing device. The user interface generator may generate a personalized user interface based on a user tier and labeled narrated media content and may transmit the personalized user interface to the user's computing device to be presented. The personalized user interface may be transmitted via a network communication device. In an alternative embodiment, the personalized user interface is generated on the user's computing device.

In alternative embodiments, some of the operations shown in the method 1000 may be performed in a different order. For example, the media description file received during the operation 1004 may be received before the narrated media content is received during the operation 1002. In further alternative embodiments, some of the operation shown in the method 1000 may be performed at substantially the same time. For example, the media description file received during the operation 1004 may be received at substantially the same time as the narrated media content during the operation 1002.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A method for automatically organizing narrated media content based on a media description file, the method comprising:
receiving, at a server, two or more narrated audio and/or video recordings;
receiving a media description file together with the two or more narrated audio and/or video recordings;
automatically labeling two or more narrated audio and/or video recordings based on the media description file; and
communicating, to a media playback device, visual data after the labeling.

2. The method of claim 1, wherein the media description file defines at least relational information between the two or more narrated audio and/or video recordings of a media program.

3. The method of claim 2, wherein the media description file further provides definitions of:
one or more access tiers of the two or more narrated audio and/or video recordings;
geographical restrictions of the two or more narrated audio and/or video recordings;
additional content associated with the two or more narrated audio and/or video recordings; and
condensed content of one or more of the two or more narrated audio and/or video recordings.

4. The method of claim 3, wherein the visual data includes visual elements that indicate one or more of the definitions.

5. The method of claim 3, wherein the additional content is one or more of audio data, video data, graphical data, and textual data.

6. The method of claim 3, wherein the definition of the one or more access tiers of the two or more narrated audio and/or video recordings is associated with subscription tiers of a user account.

7. The method of claim 1, wherein the media description file defines relational information between one or more of the two or more narrated audio and/or video recordings and a different media program.

8. The method of claim 1, wherein the media description file is written in markup language format.

9. The method of claim 1, further comprising:
receiving, at a media delivery host, a media content link referencing the two or more narrated audio and/or video recordings; and
receiving, at the media delivery host, a description file link referencing the media description file.

10. The method of claim 9, wherein the two or more narrated audio and/or video recordings are received, at the server, using the media content link, and the media description file is received using the description file link.

11. A system for automatically organizing narrated media content based on a media description file, the system comprising:
one or more processors; and
one or more computer-readable storage devices storing data instructions that, when executed by the one or more processors, cause the system to:
receive two or more narrated media content items;
receive a media description file associated with the two or more narrated media content items;
automatically label the two or more narrated media content items based on the media description file, wherein labels assign each of the two or more narrated media content items to a tier;
receive a request to view a media program for a user account; and
cause a device to display a user interface including at least one of the two or more narrated media content items,
wherein when the user account is associated with a first tier, the user interface includes visual data associated with a first media content item of the two or more narrated media content items, or
wherein when the user account is associated with a second tier, the user interface includes visual data associated with a second media content item of the two or more narrated media content items.

12. The system of claim 11, wherein the labels further define a relationship between the two or more narrated media content items.

13. The system of claim 12, wherein the first media content item is a first version of an episode and the second media content item is a second version of the episode.

14. The system of claim 11, wherein if the user account is associated with a first tier, the user interface does not include the second media content item.

15. The system of claim 11, wherein the two or more narrated media content items are episodes of a podcast.

16. A non-transitory computer-readable medium having stored thereon data instruction that, when executed by one or more processors, cause the one or more processors to:
receive a narrated media content item;
receive a media description file associated with the narrated media content item, wherein the media description file describes an entitlement for the narrated media content item;
automatically associate the narrated media content item with a subscription tier based on the entitlement;
receive a request from a user to view a media program, the media program having a first feed associated with a first subscription tier and a second feed associated with a second subscription tier;
automatically select a feed based on a subscription tier of the user; and
cause a device to display a user interface, wherein the user interface includes the selected feed.

17. The computer-readable medium of claim 16, wherein the first feed includes the narrated media content item and the second feed does not contain the narrated media content item.

18. The computer-readable medium of claim 17, wherein the second feed includes a second narrated media content item, wherein the second media content item is an alternative version of the narrated media content item.

19. The computer-readable medium of claim 18, wherein the media description file describes an association between the narrated media content item and the second media content item.

20. The computer-readable medium of claim 16, wherein
the first feed includes a first listing of the narrated media content item, the first listing having an activatable control, wherein activation of the activatable control causes the device to present the narrated media content item; and
the second feed includes a second listing of the narrated media content item, the second listing having an indication that the narrated media content item is not available for users associated with the second subscription tier.
